(19) United States
(12) Patent Application Publication
(10) Pub. No.: US 2016/0219405 A1
(43) Pub. Date: Jul. 28, 2016

(54) SYSTEM AND METHOD FOR ENHANCED BEACONS DETECTION AND SWITCHING

(71) Applicant: MOBSTAC INC.

(72) Inventors: RAVISH MISHRA, BANGALORE (IN); KSHITIJ DEO, BANGALORE (IN); RAVI PRATAP MADDIMSETTY, BANGALORE (IN)

(21) Appl. No.: 14/603,766

(22) Filed: Jan. 23, 2015

(51) Int. Cl. H04W 4/02; H04W 4/00

(52) U.S. Cl. CPC H04W 4/023; H04W 4/008

(57) ABSTRACT

A method and system for enhanced beacons detection and switching is disclosed. A reference graph is obtained by plotting variations of signal strength with respect to distance from the beacon for each type of the electronic device. Regions are demarcated around the beacons for a chosen range of signal strengths using the reference graphs for particular devices. A negative bias added to all the beacon regions till a device crosses the region threshold to filter off any rogue signals detected by the device. Once a device enters a beacon region a positive bias is added to that particular beacon region while maintaining the negative bias for the rest of the beacon regions. To maintain stickiness the minimum of a set of greatest signal values is taken. The signal reception rate is also tweaked to achieve optimal balance between detected signal accuracy and battery life of the broadcasting beacon.

### FIELD OF INVENTION

The present invention, in general, relates to wireless communication systems and methods. More particularly, the present invention relates to a system and method of enhanced beacons detection and switching used in proximity detection.

### BACKGROUND OF THE INVENTION

iBeacon is a low-powered, low-cost transmitter used for proximity detection. iBeacon uses Bluetooth Low Energy (BLE) proximity sensing to transmit a universally unique identifier that can be picked up by handheld devices. When iBeacon is placed in a space, it broadcasts radio signals around itself and the handheld devices for example, Smartphones, which are in range are able to “hear” these signals and communicate with iBeacon to exchange data and information.

For example, one or more iBeacon can be placed in a shopping complex and the customers with handheld devices will benefit from the personalized micro-location triggers, when they walk into the shopping complex venue or interact with the products in the shopping complex.

The problem arises when there are two or more beacons present in close proximity. In such cases, iBeacon standard provides no clear and easy way to know which beacon is closer. Further, the system and methods used to demarcate the area in which the deacons are installed are common to all categories of handheld devices. There is no specific detection and switching technique used for each type of handheld devices, as the signal strength of various devices may not be same at same location.

Further, greater the reception/transmission rate means greater the accuracy of signal strength as detected by handheld devices, but there is a tradeoff between transmission rate and battery life, greater the transmission rate lesser is the battery life. Thus, there should be a balance between the accuracy of signal rate and battery life.

A need, therefore, exists for an improved system and method that overcomes the above drawbacks.

### BRIEF DESCRIPTION OF THE INVENTION

The above-mentioned shortcomings, disadvantages and problems are addressed herein which will be understood by reading and understanding the following specification.

It is, therefore, one aim of the disclosed embodiments to provide a method for enhanced beacons detection and switching comprising providing one or more beacons for transmitting beacons signals for proximity detection in an area, configuring one or more electronic handheld devices to detect the beacon signals, obtaining one or more reference tables for each electronic handheld devices from a server, demarcating regions in the area for each electronic handheld device based on its reference table, adding a negative bias to all the regions of all beacons till at least one of the electronic handheld devices crosses its demarcated region, adding a positive signal bias to the demarcated region when one of the electronic handheld device crosses its demarcated region and maintaining a negative signal bias for rest of the demarcated regions of the one of the electronic device.

It is, therefore, one aim of the disclosed embodiments to provide the system for enhanced beacons detection and switching comprising one or more beacons for transmitting beacons signals for proximity detection in an area, one or more electronic handheld devices installed with at least one application to detect the beacon signals and a server in communication with the electronic handheld devices having at least one database for storing one or more reference tables. The server is configured to obtain one or more reference tables for each electronic handheld devices from the database, demarcate regions in the area for each electronic handheld device based on its reference table, add a negative bias to all the regions of all beacons till when at least one of the electronic handheld devices crosses its demarcated region, add a positive signal bias to the demarcated region when one of the electronic handheld device crosses its demarcated region and maintain a negative signal bias for rest of the demarcated regions of the one of the electronic device.

It is, therefore, one aim of the disclosed embodiments to provide the system and method for enhanced beacons detection and switching in which regions are demarcated based on particular device in the area in which the beacons are installed.

It is, therefore, one aim of the disclosed embodiments to provide the system and method for enhanced beacons detection and switching further comprising configuring the electronic handheld devices to send a trigger signal along with device and location information to the server to notify its presence inside the area.

It is, therefore, one aim of the disclosed embodiments to provide the system and method for enhanced beacons detection and switching further comprising modifying bias of the beacon signals when the electronic handheld device moves from the demarcated region to other demarcated region.

It is, therefore, one aim of the disclosed embodiments to provide the system and method for enhanced beacons detection and switching further comprising switching the signal strength of the beacons signals for the electronic device based on the location of the electronic device.

It is, therefore, one aim of the disclosed embodiments to provide the system and method for enhanced beacons detection and switching in which modifying bias of beacon signals includes adding the negative signal bias to all regions and adding the positive signal bias to the demarcated region in which the electronic device is currently present.

It is, therefore, one aim of the disclosed embodiments to provide the system and method for enhanced beacons detection and switching in which the reference tables for the electronic handheld device is obtained by entering various signal level data and distance data of the electronic handheld device from one or more beacons and storing the reference tables in a database.

It is, therefore, one aim of the disclosed embodiments to provide the system and method for enhanced beacons detection and switching in which the signal level data is the signal level of the electronic handheld device at various locations in the area.

It is, therefore, one aim of the disclosed embodiments to provide the system and method for enhanced beacons detection and switching in which the distance data is distance of the electronic handheld device from the beacons.

It is, therefore, one aim of the disclosed embodiments to provide the system and method for enhanced beacons detection and switching further comprising maintaining signal stickiness in the electronic device for the beacons by taking minimum of a set of greatest signal levels of the beacons.

It is, therefore, one aim of the disclosed embodiments to provide the system and method for enhanced beacons detection and switching in which the demarcating regions in the area is obtained by demarcating regions around the beacons for a chosen range of signal strengths using the reference tables for the electronic handheld devices.

It is, therefore, one aim of the disclosed embodiments to provide the system and method for enhanced beacons detection and switching further comprising configuring the beacons to broadcast signals at an optimal rate based on its battery life.

It is, therefore, one aim of the disclosed embodiments to provide the system and method for enhanced beacons detection and switching further comprising configuring the signal strengths of beacons such that one of the electronic devices at demarcated region inside the area is clamped on by one of the nearest beacon.

It is, therefore, one aim of the disclosed embodiments to provide the system for enhanced beacons detection and switching in which the application allows the electronic handheld devices to communicate data to the server and/or beacons.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 is an illustration of a system for enhanced beacons detection and switching used in proximity detection;

FIG. 2 is an illustration of a reference graph utilized in beacons detection and switching;

FIG. 3 is an illustration of a schematic diagram showing a handheld device away from an area installed with a number of beacons for proximity detection;

FIG. 4 is an illustration of a schematic diagram showing the handheld devices entered inside an region in the area depicted in FIG. 3;

FIG. 5 is an illustration of a schematic diagram showing the handheld devices entered in another region in the area from the region depicted in FIG. 4; and

FIGS. 6A-6B are illustrations of a flow chart depicting a method for enhanced beacons detection and switching.

### DETAILED DESCRIPTION OF THE INVENTION

The particular values and configurations discussed in these non-limiting examples can be varied and are cited merely to illustrate at least one embodiment and are not intended to limit the scope thereof.

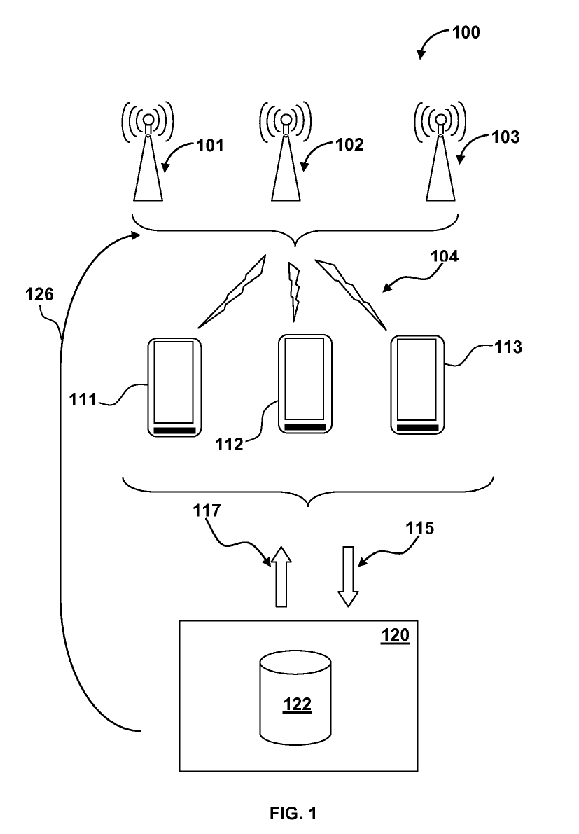

Referring to FIG. 1, a schematic diagram of a system 100 for enhanced beacon detection and switching is disclosed. The system 100 has one or more beacons, for example, as shown, has three beacon devices 101, 102 and 103 for broadcasting Bluetooth Low Energy (BLE) signal 104 for proximity detection of handheld electronic devices 111, 112 and 113. The handheld electronic devices 111, 112 and 113 can be a Mobile Equipment (ME).The beacons 101, 102 and 103 are a type of signaling devices and the system 100 can use other types, for example, an ultrasound device and/or a Bluetooth Low Energy (BLE) device without limitation. It may be noted that these are exemplary implementations and the teachings of the present invention can be practiced using other short range technologies. The various types of handheld device 111, 112 and 113 includes without limitation, cellular phones, smart phones, personal digital assistants, tablet computers, and handheld multimedia players. Smart phones include without limitation, iPods, tablets, etc. Though three handheld devices 111, 112 and 113 are shown in the figure for clarity, a number of handheld devices may communicate with the beacons. An application corresponding to the beacon detection is installed on the handheld devices 111, 112 and 113.

The server 120 has at least one database 112 for storing one or more reference tables that are specific to a type of handheld device. For example, the database 112 can have one or more reference tables corresponding to a smartphone, one or more reference tables corresponding to a tablet computer, etc. It should be noted that the reference tables for each type of electronic handheld device is a preset table obtained by entering various signal level data and distance data of the electronic handheld device from each beacons. The area in which one or more beacons are installed is demarcated into regions based on higher degree of signal strength using the reference tables. In one embodiment, the database 112 can also store the demarcating regions corresponding to each electronic device.

When an electronic device (111 or 120 or 113) of one type enters the area in which one or more beacons (111 or 120 or 113) are installed, the application in the electronic device sends trigger signal along with device and location information 115 to the server 120 to notify its presence inside the area. The server 120 accordingly sends the signal biasing information 117 to the electronic device.

It should be noted that by demarcating the area into regions and controlling the signal bias of the beacons based on the region in which the electronic device is present, the electronic device can detect only the beacon of that particular region. Further, for example, in a shopping complex, the shops from server can send offers, announcements, deals, etc, to the electronic device of the customer who are very near to their products or shop.

It should also be noted that getting bias information from the server to the handheld electronic devices or Mobile Equipment (ME) is one method of demarcating regions, when multiple beacons are deployed. ME application may have the logic to apply bias to the beacon signal strength. Tablet computers behave differently from mobile phones. Bigger devices receive better signal strength than smaller devices, hence calibration data will be collected separately for different devices for example, separate tables will be created for iPod, iPad, iPad mini, and iPhone respectively. Multiple ME can detect same beacon. The devices work independently of each other.

It should also be noted that the electronic device 111, 112 and 113 can be configured to send a signal 126 to each of the beacons 101, 102 and 103, to change the setting of signal broadcast rate. Greater reception/transmission rate means greater accuracy of signal strength as detected by the electronic devices 111, 112 and 113, but there is a tradeoff between transmission rate and battery life, greater the transmission rate lesser is the battery life. To achieve a good balance between the accuracy of signal rate and battery life, an agreeable optimal value of signal broadcasting rate is used.

The server 120 communicates with the electronic devices 111, 112 and 113 via a packet-switched network, for example, Internet. In one embodiment, the server 120 is a controlling unit, for example, a control server that can control the signal broadcast rate of the beacons 101, 102 and 103 via the electronic devices 111, 112 and 113. In another embodiment, the server 120 is a processing device, for example, a server that can process the location and device information of electronic devices 111, 112 and 113 and accordingly switch the signal biasing. The server 110 may be located within or outside the area in which the beacons are installed.

It should be noted that positive bias will be added to the beacon, in which the mobile equipment is currently camped on and negative bias will be added to all other beacon Received Signal Strength Indicator (RSSI), i.e. perceived signal strength.

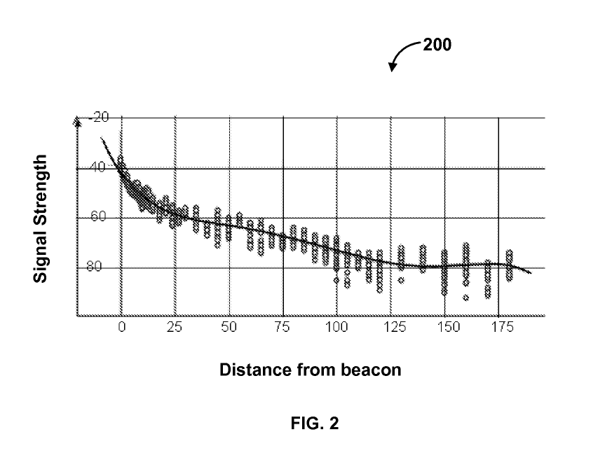

FIG. 2 is an illustration of a reference graph 200 utilized in beacons detection and switching. The reference graphs 200 shown in FIG. 2 are stored as reference table in the database. The graph 200 shows the signal strength at various locations inside the area in which the beacons are installed. The graph 200 is for one type of electronic device and similar such graphs can also be stored as tables in database for other types of electronic devices. The reference graph 200 is referred as Received Signal Strength Indicator (RSSI) graph.

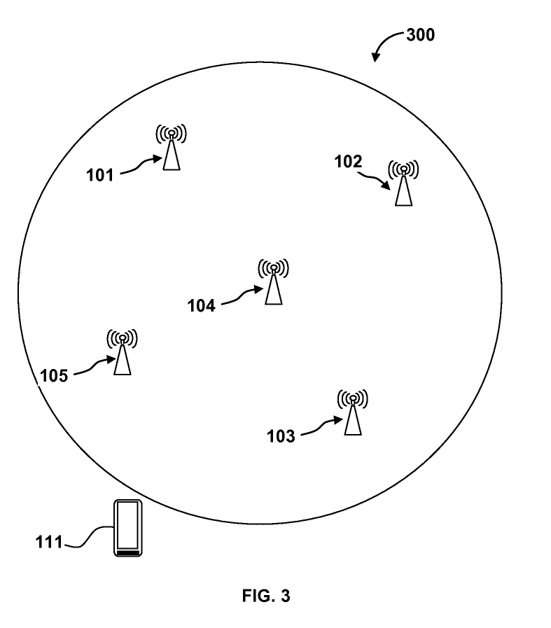

Referring to FIG. 3, a schematic diagram showing a handheld device 111 away from an area 300 installed with a number of beacons 101-105 for proximity detection is disclosed. A negative bias is added to all the beacon regions until the handheld device 111 crosses the region threshold to filter off any rogue signals detected by the handheld device 111. It should be noted that the server can identify the type of the electronic device 111 when the electronic device 111 enters the area 300 and is triggered by any of the beacons 101-105 in the area 300.

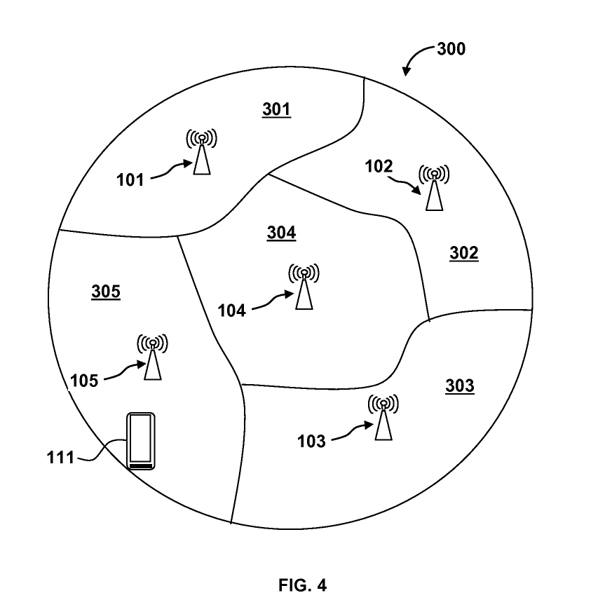

Once the electronic device 111 enters the area 300, as shown in FIG. 4, the electronic device 111 detects the beacon signal and sends the trigger signal along with location and device information to the server 120 depicted in FIG. 1. The server 120 can then demarcate the area 300 into regions 301-305 based on the reference table specific to the device 111. Based on the region in which the device 111 is present, the server 120 adds a positive bias to that region and maintains negative bias in all other regions.

Based on the biasing information, the signal strength of each beacon for that particular device is altered. For example, when the electronic device is in the demarcated region 305, the server based on its present region may send biasing information. The signal strength of the beacon 105 that corresponds to the demarcated region 305 in which the electronic device 111 is present is positive biased while the other regions 301-304 are negative biased.

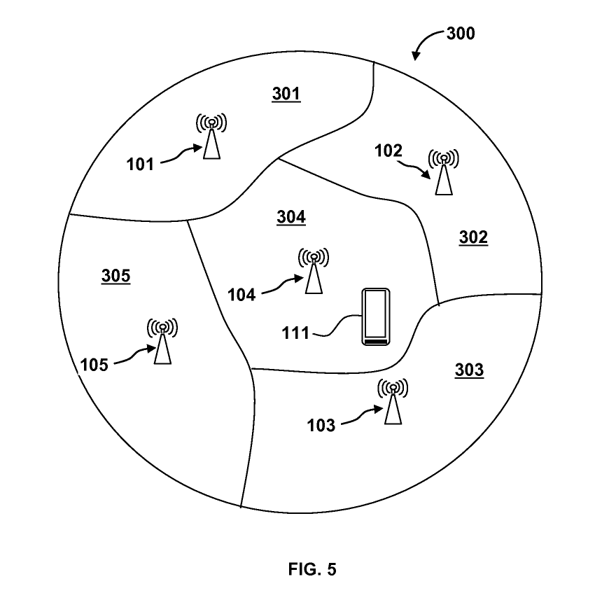

Referring to FIG. 5, a schematic diagram showing a handheld device 111 moved from the region 305 to another region 304 in the area 300 is disclosed. When the electronic device 111 is moved from the region 305 to other region 304, the server based on the present region 304 may send the biasing information. The signal strength of the beacon 104 that corresponds to the demarcated region 304 in which the electronic device 111 is present is positive biased while the other regions 301-303 and 305 are negative biased. This provides a clean and precise way of knowing which beacon is near to a high degree of confidence. It should be noted that when the electronic device 111 does not enter the area in which the beacons are present, all the regions are negative biased and the electronic device cannot detect any on the beacon signals.

It should be noted that at any point of time, an electronic device will belong to one region only. Suppose ME is currently camped on beacon 105 and it is moving towards beacon 104. Positive bias will be applied to beacon 105 and negative bias will be applied to beacon 104. As the electronic device moves the signal strength of 104 improves. Gradually the negative biased signal strength of 104 becomes better than positively biased signal strength of 105. As this point the electronic dcamps on 104. Positive bias is applied to 104 and negative bias is applied to 105.

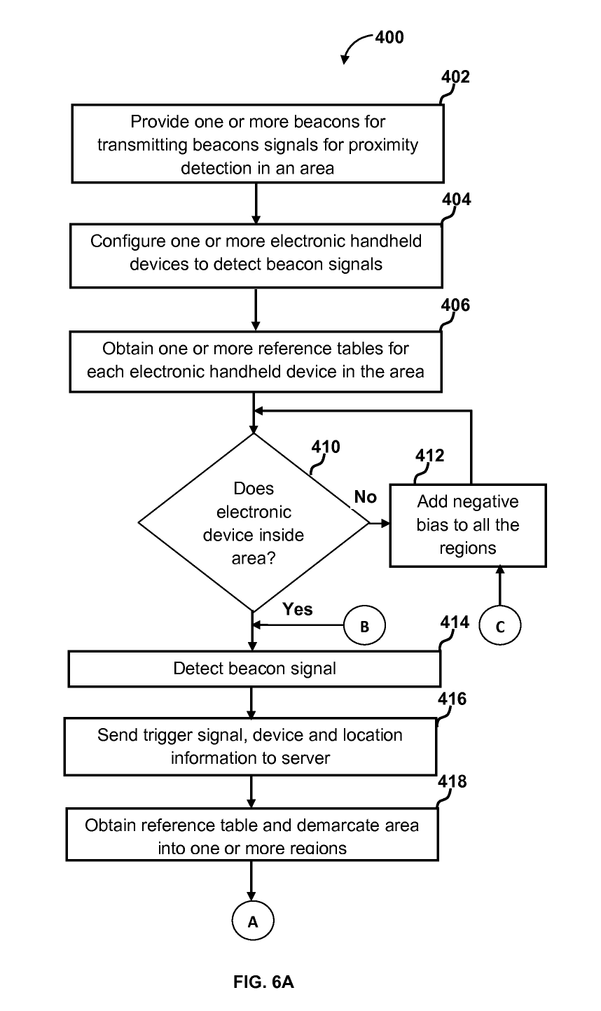

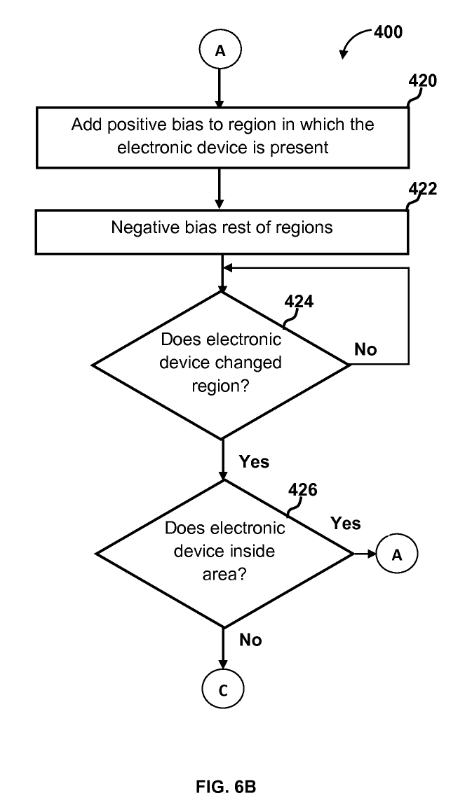

Referring to FIGS. 6A-6B, a flow chart 400 depicting a method for enhanced beacon detection and switching by utilizing the system 100 depicted in FIG. 1 is disclosed. As said at block 402, one or more beacons are provided in an area for transmitting the beacon signals for proximity detection. One or more electronic devices are configured to detect the beacon signals when they enter the area, as depicted at block 404. As depicted at block 406, one or more reference tables for different types of the electronic handheld device, at different location of the area are obtained. The reference table is a preset table previously obtained for each type of electronic devices that are compatible with the present system.

As said at blocks 410 and 414, when one of the electronic devices enters the area, it detects the beacon signal around it. Upon detection the electronic device sends a trigger signal, location and device information to the server, as said at block 416. The server can process the received information and accordingly modify the signal bias for the electronic device. When the electronic device is not inside the area, as said at block 412, a negative bias is added to all the regions and hence the electronic device cannot detect the beacon signals.

Based on the device and location information from the electronic device, as said at block 418, a reference table corresponding to the device is obtained from the server and the area in which the beacons are present is demarcated into various regions based on the reference table data.

As depicted at block 420 and 422, the region in which the electronic device is present is positive biased while maintaining the negative bias in rest of the regions.

As depicted at blocks 424 and 426, the system checks whether the electronic device has changed region and whether it is inside the area. When the electronic device has changed the region, the system checks whether the electronic device is inside the area. If the electronic device is inside the area but in other region, the system again performs the blocks 420 and 422, else the system performs the block 412.

It should be noted that once a device enters a beacon region a positive bias is added to that particular beacon region while maintaining the negative bias for the rest of the beacon regions. A device will be termed “exited” from the beacon region only if it crosses the threshold (including positive bias). To maintain stickiness the minimum of a set of greatest signal values is taken. The signal reception rate is also tweaked based on experiments to achieve optimal balance between detected signal accuracy and battery life of the broadcasting beacon.

From the written description it is clear that the regions are demarcated around the beacons for a chosen range of signal strengths using the reference graphs for particular devices. For example, a region zone (like near, immediate, far) is demarcated using a particular value of signal strength like −70 dB, for a particular device like iPad/iPhone. If the device receives a signal which is greater than −70 dB, it's considered to be in that particular zone. Also, the signal reception rate is also tweaked to achieve optimal balance between detected signal accuracy and battery life of the broadcasting beacon.

This written description uses examples to describe the subject matter herein, including the best prediction mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for enhanced beacons detection and switching comprising:
providing one or more beacons for transmitting beacons signals for proximity detection in an area;
configuring one or more electronic handheld devices to detect the beacon signals;
obtaining one or more reference tables for each electronic handheld devices from a server;
demarcating regions in the area for each electronic handheld device based on its reference table;
adding a negative bias to all the regions of all beacons till at least one of the electronic handheld devices crosses a demarcated region;
adding a positive signal bias to the demarcated region when one of the electronic handheld device crosses the demarcated region such that the electronic device is clamped by one of the beacons; and
maintaining a negative signal bias for rest of the demarcated regions of the one of the electronic device.

2. The method of claim 1 further comprising:
configuring the electronic handheld devices to send a trigger signal along with device and location information to a server to notify its presence inside the area.

3. The method of claim 1 further comprising:
modifying bias of the beacon signals when the electronic handheld device moves from the demarcated region to other demarcated region.

4. The method of claim 1 further comprising:
switching the signal strength of the beacon signals for the electronic device based on the location of the electronic device.

5. The method of claim 3, wherein modifying bias of beacon signals includes:
adding the negative signal bias to all regions; and
adding the positive signal bias to the other demarcated region in which the electronic device is currently present.

6. The method of claim 1, wherein the reference tables for the electronic handheld device is obtained by:
entering various signal level data and distance data of the electronic handheld device from one or more beacons; and
storing the reference tables in a database.

7. The method of claim 6, wherein the signal level data is the signal level of the electronic handheld device at various locations in the area.

8. The method of claim 6, wherein the distance data is distance of the electronic handheld device from the beacons.

9. The method of claim 1 further comprising:
maintaining signal stickiness in the electronic device for the beacons by taking minimum of a set of greatest signal levels of the beacons.

10. The method of claim 1, wherein the demarcating region in the area is obtained by demarcating regions around the beacons for a chosen range of signal strengths using the reference tables for the electronic handheld devices.

11. The method of claim 1 further comprising configuring the beacons to broadcast signals at the optimal rate to increase the battery life of the electronic handheld devices.

12. The method of claim 1 further comprising configuring the signal strengths of beacons such that one of the electronic devices at demarcated region inside the area is clamped on by one of the nearest beacons.

13. A system for enhanced beacons detection and switching comprising:
one or more beacons for transmitting beacons signals for proximity detection in an area;
one or more electronic handheld devices installed with at least one application to detect the beacon signals; and
a server in communication with the electronic handheld devices comprising at least one database for storing one or more reference tables,
wherein the server is configured to:
obtain one or more reference tables for each electronic handheld devices from the database;
demarcate regions in the area for each electronic handheld device based on its reference table;
add a negative bias to all the regions of all beacons till when at least one of the electronic handheld devices crosses its demarcated region;
add a positive signal bias to the demarcated region when one of the electronic handheld device crosses its demarcated region such that the electronic device is clamped by one of the beacons; and
maintain a negative signal bias for rest of the demarcated regions of the one of the electronic device.

14. The system of claim 13, wherein the electronic handheld devices are configured to send a trigger signal along with device and location information to the server to notify its presence inside the area.

15. The system of claim 13, wherein the reference tables for the electronic handheld device is obtained by entering various signal level data and distance data of the electronic handheld device.

16. The system of claim 15, wherein the distance data is distance of the electronic handheld device from the beacons.

17. The system of claim 13, wherein the server modifies bias of the beacon signals when the electronic handheld device moves from the demarcated region to other demarcated region.

18. The system of claim 13, wherein the server maintains stickiness of the beacon signal in the electronic device for the beacons by taking minimum of a set of greatest signal levels of the beacons.

19. The system of claim 13, wherein the demarcating regions in the area is obtained by demarcating regions around the beacons for a chosen range of signal strengths using the reference tables for the electronic handheld devices.

20. The system of claim 13, wherein the beacons are configured to broadcast signals at the optimal rate to increase the battery life of the electronic handheld devices.

21. The system of claim 13, wherein the application allows the electronic handheld devices to communicate data to the beacons.

22. The system of claim 13, wherein the application allows the electronic handheld devices to communicate data to the server and beacons.

23. The system of claim 13, wherein the signal strengths of beacons is configured such that one of the electronic devices at demarcated region inside the area is clamped on by one of the nearest beacons.
